(19) United States
(12) Patent Application Publication
(10) Pub. No.: US 2019/0318411 A1
(43) Pub. Date: Oct. 17, 2019

(54) Recommendation Engine

(71) Applicant: SIEMENS SCHWEIZ AG, Zurich (CH)

(72) Inventors: Deepak Dhungana, Seyring (AT); Max Paul Ehlmaier, Wien (AT); Alain Debrot, Baar (CH)

(21) Appl. No.: 16/381,883

(22) Filed: Apr. 11, 2019

(30) Foreign Application Priority Data
Apr. 12, 2018 (EP) 18167090.2

(51) Int. Cl. G06Q 30/06; G06F 17/16; G06Q 30/02; G06K 9/62

(52) U.S. Cl. CPC G06Q 30/0631; G06K 9/6215; G06Q 30/0207; G06F 17/16

(57) ABSTRACT

Recommendation engine for evaluating Offerings in a procurement process and generating a selection of the Offerings, wherein the relationship between Offerings and procurers requirements is modeled in matrices, vector representations for the Offerings are generated based on the matrices, similarity values are calculated for the Offerings, and based on the similarity values a selection and ranking of the Offerings is provided.

### BACKGROUND OF THE INVENTION

### 1. Field of the Invention

The invention relates to a computer implemented recommendation engine for evaluating offerings in a procurement process and generating a selection of the offerings.

### 2. Description of the Related Art

Recommendation engines or recommender systems are a subclass of information filtering systems that seek to predict the “rating” or “preference” that a user would give to an item.

In other words, such systems analyze available data to make suggestions for something that a website user might be interested in, such as a service, or a device.

According to the state of the art two basic principles are used for recommendation systems:

Collaborative filtering, also referred to as social filtering, filters information by using the recommendations of other people. Collaborative filtering is based on the idea that people who agreed in their evaluation of certain items in the past are likely to agree again in the future. A person who wants to see a movie for example, might ask for recommendations from friends. The recommendations of some friends who have similar interests are trusted more than recommendations from others. This information is used in the decision on which movie to see. Collaborative filtering is often based on matrix factorization techniques.

However, collaborative filtering is not applicable when data about other users and their preferences is missing.

The second basic principle of content-based filtering is based on a description of the item and a profile of the user's preference. In a content-based recommender system, keywords are used to describe the items and a user profile is built to indicate the type of item this user prefers. In other words, these algorithms try to recommend items that are similar to those that a user chose in the past. In particular, various candidate items are compared with items previously rated by the user and the best-matching items are recommended.

Apart from recommendation engines, techniques from the world of product configuration are also known, which solve related problems, such as “guided selling”, which is a process that helps potential buyers of products or services to choose the product best fulfilling their needs and hopefully guides the buyer to buy.

It also helps vendors of products to actively guide their customers in a procurement process to a decision. Typically, guided procurement approaches are implemented constraint satisfaction problems. The boolean satisfiability problem, the satisfiability modulo theories and answer set programming can be roughly thought of as certain forms of the constraint satisfaction problem.

Although this approach initially seems to solve the described problem, the challenge of recommending products based on a calculated relevance ranking for the items is not solved by constraint satisfaction problems. The solution generated by such solvers is typically a true or false decision, meaning that either a product or service is well suited for the customer or it is forbidden by the constraints. In the instant case, the customer should also be able to select elements, that may seem to be counter intuitive for the recommendation engine, i.e., the customer decides and the recommendation engine must follow his behavior pattern.

### SUMMARY OF THE INVENTION

It is therefore an object of the present invention to provide an improved computer implemented recommendation engine, which overcomes the above mentioned disadvantages.

This and other objects and advantages are achieved in accordance with the invention by a computer implemented recommendation engine.

For evaluating offerings in a procurement process and generating a selection of the offerings, with the consideration of high level customer goals and project context data, the recommendation engine provides optimized results, and the recommendations reflect the demands of the customer in an optimal way.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows an overview of the method in accordance with the invention;

FIG. 2 shows a schematic of the handling of “static data” in accordance with the invention;

FIG. 3 shows an example of an availability matrix for a preferred embodiment in accordance with the invention;

FIG. 4 shows an example of a “utility matrix” for a preferred embodiment in accordance with the invention;

FIG. 5 shows an example for a project context matrix in accordance with the invention;

FIG. 6 shows the input data for exemplary customer motivators in accordance with the invention;

FIG. 7 shows an example of an user interaction matrix in accordance with the invention;

FIG. 8 shows the vector representation of an exemplary application of the invention in accordance with the invention; and

FIG. 9 shows an schematic illustration of an embodiment the invention.

### DETAILED DESCRIPTION OF THE EXEMPLARY EMBODIMENTS

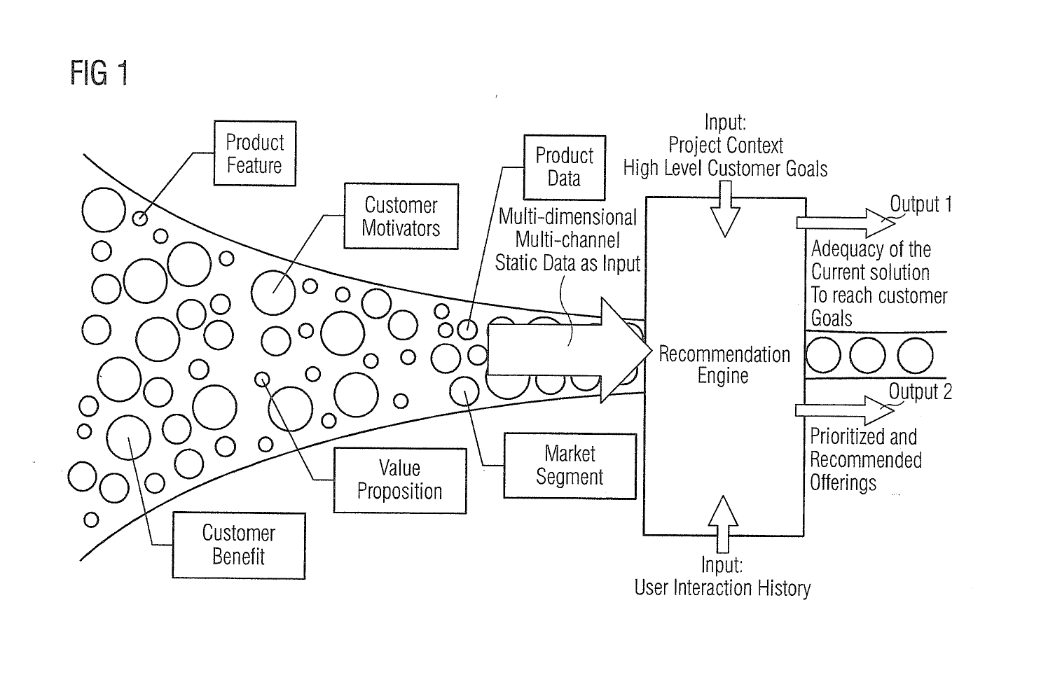

As shown in FIG. 1, the invented recommendation engine deals with three types of input:
static data in the form of product features, customer pain points, customer values/benefits, market information like the market segment or even the different kinds of customer profiles.
customer data (project context) in the form of the type of market that is being considered at the moment or the benefits that are of high importance for the customer.
user interaction data in the form of the Offerings that are being selected by the customer in the current configuration project.

The output of the engine is then a set of Offerings, matching the customer profile and related to the previous selections of the customer, contributing to the benefits that the customer wishes to get. Additionally, the system calculates how well the customer target to reach a certain high level goal has been met.

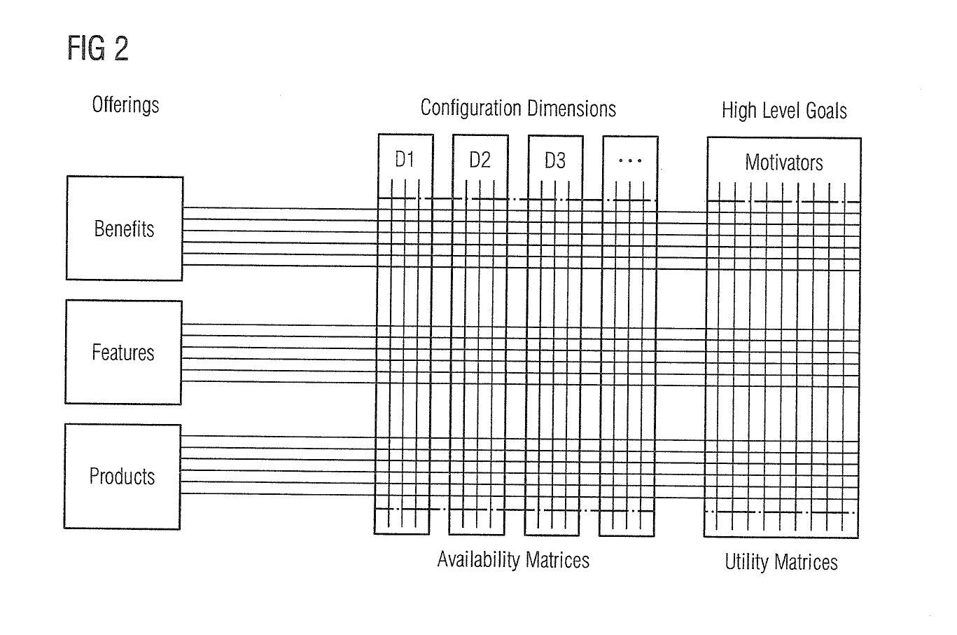

As shown in FIG. 2, the actual Offerings (e.g., product features, customer benefits and the products) for a certain distribution project are statically modeled. The configuration dimensions represent the criteria for the variation points in the Offerings. The high level goals represent the customer motivators to buy a solution in any given domain.

The relationship between Offerings and configuration dimensions is modeled in Boolean matrices, i.e., “availability matrices”. The relationship between Offerings and high level goals is modeled in the form of utility matrices (a good way of representing quantified information about the relationships between elements). The value in each cell of the matrix (representing the relationship between a certain Offering and a high level goal) specifies the degree of impact of the Offering on a certain high level goal of the user.

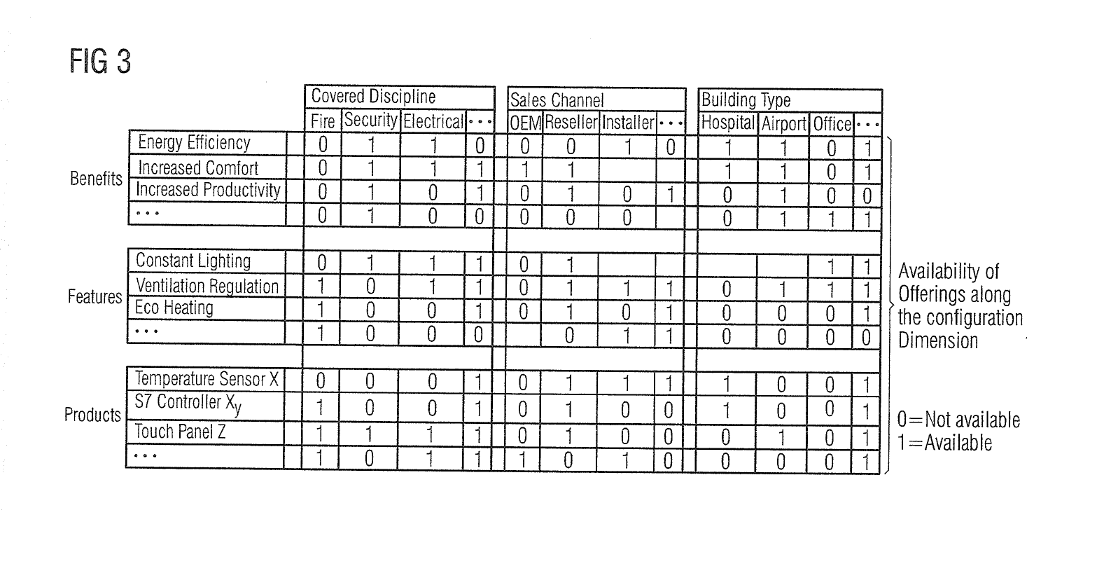

FIG. 3 shows an exemplary availability matrix for the use of the invention in a distribution project for a building automation solution. Here, exemplary products can be automation controllers, sensors, touch panels etc. Exemplary features could be “constant lighting”, or “automated ventilation regulation”.

Exemplary benefits for the customers can be “increased productivity”, in “energy efficiency”. Some configuration dimensions could be the covered discipline (e.g., Fire, Security, and Electrical), the addressed distribution channel, the building type that is being considered (e.g., Hospital, Airport, or Office building).

The value in each cell of the matrix (0 or 1) indicates the availability of a certain “Offering” for a “Configuration Dimension”.

In a preferred embodiment, the cells of the matrix are prefilled with 0 as a result, it is only necessary to fill in values in cells where a certain “Offering” is available for a “Configuration Dimension”.

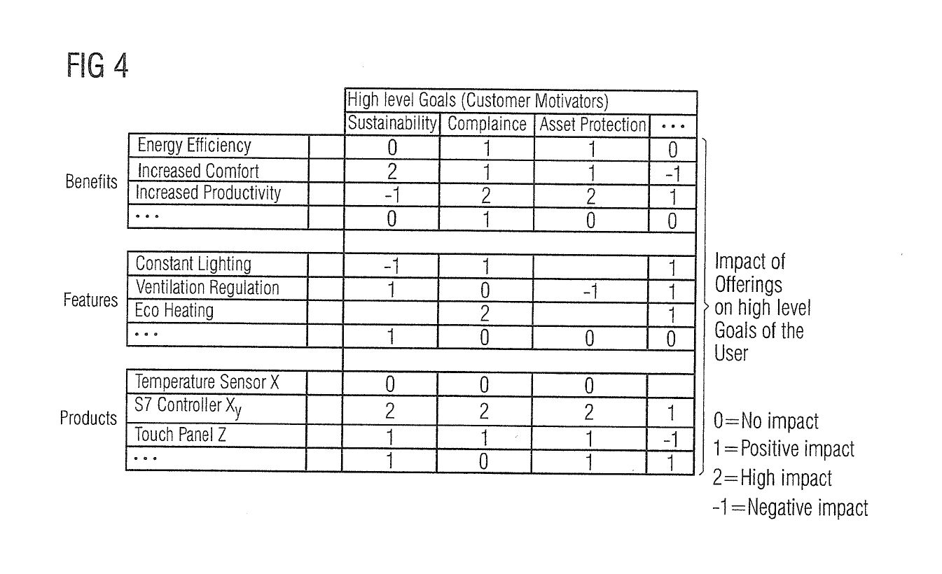

FIG. 4 shows an example of an utility matrix for the above mentioned distribution project for a building automation solution.

As the relationship between “Offerings” and “High Level Goals” is more complex than the availability of “Offerings” for “Configuration Dimension”, the values in the cells of the utility matrix have a broader range, in the present example from −1 for a negative impact to 2 for a high impact.

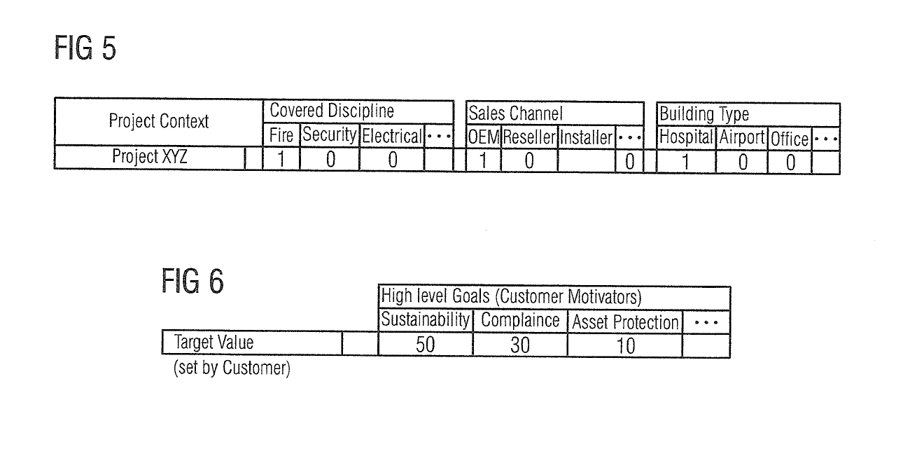

FIGS. 5, 6 show the exemplary handling of “customer data”.

In FIG. 5 an exemplary matrix for the definition of the project context by selecting one or more elements from the configuration dimension is shown. For example, the customer may be looking for a solution in the “fire” discipline, considering the possibilities of a OEM and targeting a hospital building (Building type).

FIG. 6 shows an exemplary matrix for typical customer motivators, i.e., soft facts, as sustainability, Compliance and asset protection to prefer a certain solution. In the present embodiment, the customer has set the target value for “Sustainability” to be 50, for “Compliance” to be 30 etc.

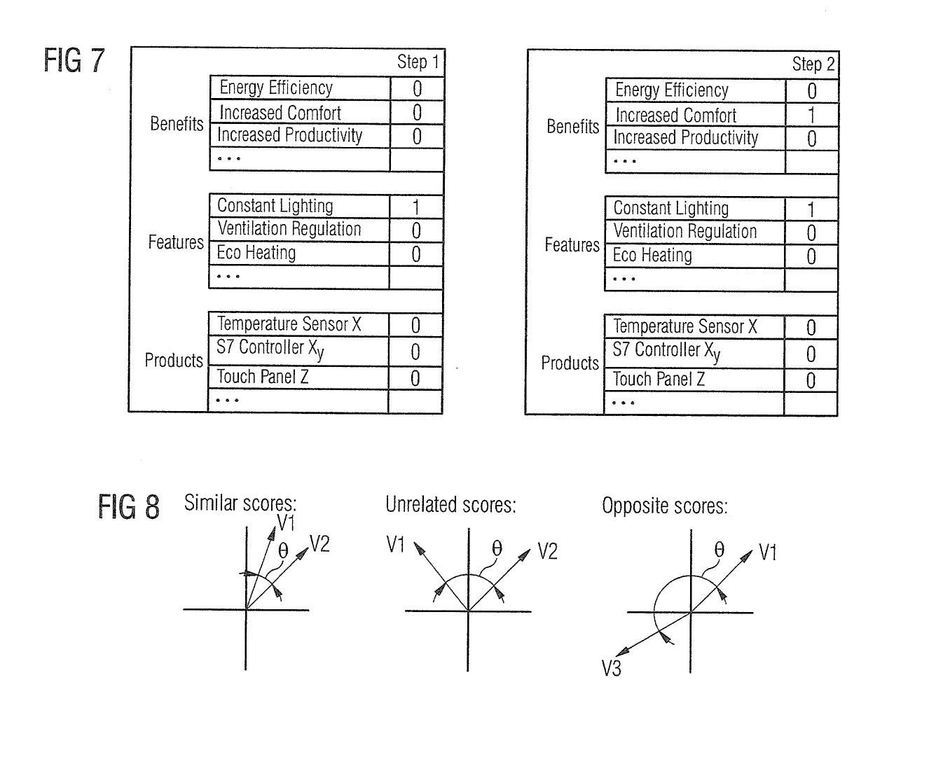

FIG. 7 shows a user interaction matrix, in which the history of the User Interaction is recorded. In accordance with the disclosed embodiments of the invention, his data will also be taken into account for the recommendations.

Based on the data in the matrices, each “Offering” is represented as an m-dimensional vector, where each dimension corresponds to a distinct configuration dimension and m is the size of the union set of all possible values of the configuration dimension.

Afterwards, the similarity of different Offerings, respectively their vector representation V1 to the vector representing the customers targets V2 is calculated.

FIG. 8 shows three different examples for the similarity between two vectors V1, V2, similar, unrelated and opposite scores.

In the present embodiment, Cosine similarity is used, which is a measure of similarity between two non-zero vectors of an inner product space that measures the cosine of the angle between them. The cosine of 0° is 1, and it is less than 1 for any other angle. It is thus a judgment of orientation and not magnitude: two vectors with the same orientation have a cosine similarity of 1, two vectors at 90° have a similarity of 0, and two vectors diametrically opposed have a similarity of −1, independent of their magnitude.

In detail, the similarity between two Vectors especially between Project Context Vector and an Offering Vector is calculated in accordance with the relationship:

$$similarity = cos ( θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}}$$

Using cosine similarity measures, it is possible to create a map of the Offerings, clearly showing how similar they are to the customer's needs as defined in the configuration dimension.

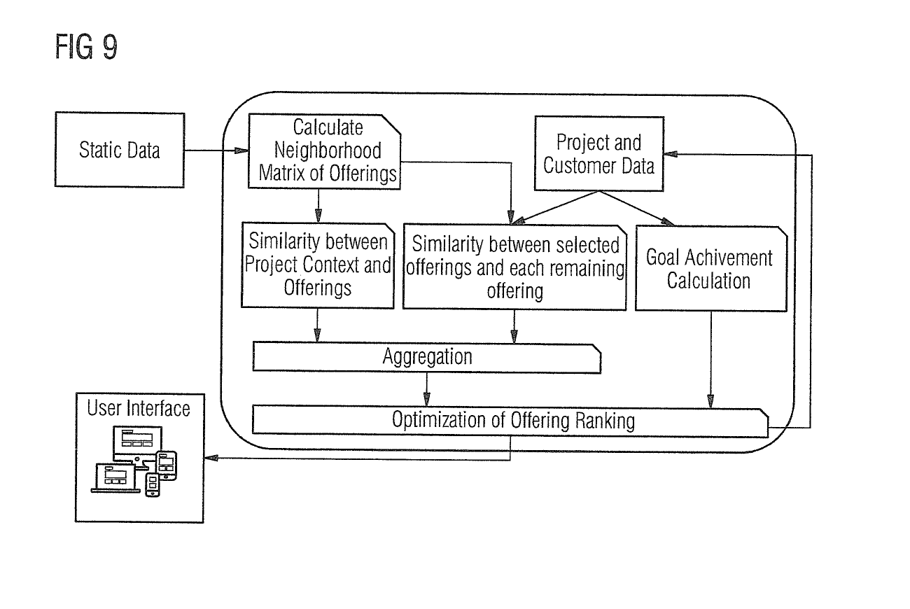

FIG. 9 is a flowchart of an exemplary recommendation process.

In a first step, neighborhood matrices of Offerings are prepared. For each Offering, its distance to the customers targets in the given vector space model is calculated and stored in the matrix.

In order to optimize the performance of the system, it may be advantageous to pre-compute the neighborhood matrix and in some cases the “project context matrix” before the user starts interacting with the system.

In a next step, project context information is exploited.

The project context can also be represented as a vector in the vector space model, as it represents a selection of elements in the configuration dimension.

In a third step, the interaction history of the user is exploited.

As the user continues with the selection of further Offerings, the recommendation engines gets more input about the “taste” of the user and can recommend items based on the previous selections. In order to do this, the current user selection is represented as a vector and the rating of the remaining Offerings is calculated as a weighted mean of the similarity coefficient of selected elements, which is available in the neighborhood matrix.

In a fourth step, the scores of step 1 and step 2 are aggregated.

To obtain fair results, the scores calculated based on the project context information and the interaction history of the user are aggregated. A simple form of aggregation would be to calculate the average of the two. But different weights maybe assigned to the individual results to specify the priorities, before a weighted average is calculated.

In step 5, the achievement of the high level goals of the customer is calculated.

Based on the current selection of the Offerings, the system is able to calculate the achieved value for each high level goal (customer motivator). This value is calculated as a weighted average of the impact of the Offering on the high level goal—the data come from the utility matrix.

In step 6, the Offering ranking is optimized.

Based on the difference between the target value of a high level goal and the calculated (achieved) value of the same goal in the current project settings, the system is then able to recommend the Offerings that would maximize the achievement of the high level customer goal.

Step 7: presentation of the result to the user.

While the invention has been illustrated and described in detail with the help of a preferred embodiment, the invention is not limited to the disclosed examples. Other variations can be deducted by those skilled in the art without leaving the scope of protection of the claimed invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A recommendation engine for evaluating Offerings in a procurement process and for generating a selection of the Offerings, the method comprising:
modelling a relationship between Offerings and requirements of procurers in matrices;
generating vector representations for the Offerings based on the matrices;
calculating similarity values for the Offerings; and
providing a selection and ranking of the Offerings based on the calculated similarity values.

2. The recommendation engine according to claim 1, wherein the requirements of procurers include static data.

3. The recommendation engine according to claim 2, wherein the static data comprises product features, project context data and user interaction data.

4. The recommendation engine according to claim 1, wherein the matrices include an availability matrix for modeling of the relationship between Offerings and configuration dimensions.

5. The recommendation engine according to claim 2, wherein the matrices include an availability matrix for modeling of the relationship between Offerings and configuration dimensions.

6. The recommendation engine according to claim 1, wherein the matrices include an utility matrix for modeling of the relationship between Offerings and high level goals.

7. The recommendation engine according to claim 2, wherein the matrices include an utility matrix for modeling of the relationship between Offerings and high level goals.

8. The recommendation engine according to claim 4, wherein the matrices include an utility matrix for modeling of the relationship between Offerings and high level goals.

9. The recommendation engine according to claim 1, wherein the matrices include at least one matrix for modeling of the relationship between Offerings and project context data.

10. The recommendation engine according to claim 1, wherein Cosine similarity is utilized.
